(19) United States
(12) Patent Application Publication
(10) Pub. No.: US 2025/0063503 A1
(43) Pub. Date: Feb. 20, 2025

(54) METHOD AND APPARATUS FOR LOW POWER WAKE UP SIGNAL IN A WIRELESS COMMUNICATION SYSTEM

(71) Applicant: Samsung Electronics Co., Ltd., Gyeonggi-do (KR)

(72) Inventors: Pengru LI, Beijing (CN); Min WU, Beijing (CN); Feifei SUN, Beijing (CN)

(21) Appl. No.: 18/796,891

(22) Filed: Aug. 7, 2024

(30) Foreign Application Priority Data
Aug. 17, 2023 (CN) 202311041847.X

(51) Int. Cl. H04W 52/02; H04W 68/02

(52) U.S. Cl. CPC H04W 52/0216; H04W 52/0229; H04W 52/0235; H04W 68/02

(57) ABSTRACT

The disclosure relates to a 5G or 6G communication system for supporting a higher data transmission rate. A method performed by a user equipment in a wireless communication system includes receiving, from a base station, configuration information related to a time-domain position of a signal, identifying the time-domain position of a first signal according to the configuration information, the first signal being used for at least one of synchronization or a radio resource management (RRM) measurement, and identifying the time-domain position of a monitoring occasion for a second signal based on the time-domain position of the first signal, the second signal being used for a wake-up.

### CROSS-REFERENCE TO RELATED APPLICATION

This application is based on and claims priority under 35 U.S.C. § 119 to Chinese Patent Application No. 202311041847.X, filed on Aug. 17, 2023, in the China National Intellectual Property Administration, the disclosure of which is incorporated herein by reference in its entirety.

### BACKGROUND

### 1. Field

The disclosure relates generally to the field of wireless communication, and more specifically, to a method and an apparatus for a low power wake-up signal in a wireless communication system.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In 5G systems, hybrid frequency shift keying (FSK) and quadrature amplitude modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed. A time-domain unit (also referred to as a time unit) herein may be an orthogonal frequency division multiplexing (OFDM) symbol, an OFDM symbol group consisting of more than one OFDM symbols, a slot, a slot group consisting of more than one slots, a subframe, a subframe group consisting of more than one subframes, a system frame, a system frame group consisting of more than one system frames, and an absolute time unit, such as 1 millisecond, 1 second, etc. The time unit may also be a combination of more than one granularities, such as N1 slots plus N2 OFDM symbols.

A frequency-domain unit (also referred to as a frequency unit) herein may be a subcarrier, a subcarrier group consisting of more than one subcarriers, a resource block RB which may also be referred to as a physical resource block PRB, a resource block group consisting of more than one RBs, a BWP, a bandwidth part group consisting of more than one BWPs, a band/carrier, a band group/carrier group, and an absolute frequency-domain unit, such as 1 hertz, 1 kilohertz, etc. The frequency-domain unit may also be a combination of more than one granularities, e.g., M1 PRBs plus M2 subcarriers.

The transmission links of a wireless communication system mainly include downlink communication links from a 5G NR gNB to a UE, uplink communication links from a UE to a network, and sidelink communication links from a UE to a UE.

In a current wireless communication system, to reduce energy consumption at the terminal side, a discontinuous reception (DRX) mechanism is introduced so that the UE may be frequently in a sleep state and is only required to be periodically waked up to monitor a paging occasion (PO). Within one DRX cycle, the UE is waked up to monitor the PO only in a DRX ON duration, after monitoring a physical downlink control channel (PDCCH) scrambled by a P-radio network temporary identifier (RNTI). The UE continues to read the paged terminal flag in the paging message. If the read terminal flag is the same as the own flag, the UE further reads the paging message; otherwise, the UE drops the paging message. In the above procedure, to further reduce the energy consumption of the UE, a paging early indication (PEI) signal is introduced to indicate whether the UE needs to monitor the corresponding PO. If the system information provides the PEI configuration, the UE monitors the PEI occasion once per DRX cycle. If the UE detects the PEI indication and the PEI indicates the UE to monitor the associated PO, the UE shall be waked up to monitor the PO at the next PO; otherwise, the UE is not required to be waked up to monitor the PO.

In a radio resource control (RRC) connected state, each DRX cycle includes an active time in which the UE needs to monitor the PDCCH, and a non-active time in which the UE does not need to monitor the PDCCH. The UE starts drx-onDuration Timer (DRX duration timer) at the start point of each DRX cycle to start monitoring the PDCCH, during transmission. If the UE monitors downlink control information (DCI) scheduling new data transmission, the UE starts a drx-inactivity Timer (DRX inactivity timer). During the DRX active time, the base station may instruct the UE to enter the DRX non-active time early by signaling, or the UE may enter the DRX non-active time when all DRX timers of the UE stop running.

In some use cases, such as with IoT and/or wearable devices where low energy consumption by the UE is vital, an enhanced wake up signal monitoring method is needed to further extend the battery life of the UE and for radio resource management (RRM) measurements.

### SUMMARY

The disclosure has been made to address at least the above-mentioned problems and/or disadvantages and to provide at least the advantages described below.

Accordingly, an aspect of the disclosure is to provide a method and apparatus for low power wake up signal (LPWUS) configuration and monitoring in a wireless communication system.

In accordance with an aspect of the disclosure, there is provided a method performed by a UE in a wireless communication system, including receiving, from a base station, configuration information related to a time-domain position of a signal, identifying the time-domain position of a first signal according to the configuration information, the first signal being used for at least one of synchronization or a radio resource management (RRM) measurement, and identifying the time-domain position of a monitoring occasion for a second signal based on the time-domain position of the first signal, the second signal being used for a wake-up.

In accordance with an aspect of the disclosure, a method performed by a base station in a wireless communication system includes transmitting, to a UE, configuration information related to a time-domain position of a signal that is used to identify a time-domain position of a first signal used for synchronization and/or an RRM measurement, and transmitting, to the UE, a second signal used for wake-up, wherein the second signal is monitored by the UE in a monitoring occasion for the second signal, and wherein a time-domain position of the monitoring occasion is identified based on the time-domain position of the first signal.

In accordance with an aspect of the disclosure, a UE includes a transceiver, and a controller coupled with the transceiver and configured to receive, from a base station, configuration information related to a time-domain position of a signal, identify a time-domain position of a first signal according to the configuration information, the first signal being used for at least one of synchronization or an RRM measurement, and identify a time-domain position of a monitoring occasion for a second signal based on the time-domain position of the first signal, the second signal being used for wake-up.

In accordance with an aspect of the disclosure, a base station includes a transceiver, and a controller coupled with the transceiver and configured to transmit, to a UE, configuration information related to a time-domain position of a signal that is used to identify a time-domain position of a first signal used for synchronization and/or an RRM measurement, and transmit, to the UE, a second signal used for wake-up, wherein the second signal is monitored by the UE in a monitoring occasion for the second signal, and wherein a time-domain position of the monitoring occasion is identified based on the time-domain position of the first signal.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 illustrates a wireless network according to an embodiment;

FIG. 2A illustrates a wireless transmission path according to an embodiment;

FIG. 2B illustrates a wireless reception path according to an embodiment;

FIG. 3A illustrates a UE according to an embodiment;

FIG. 3B illustrates a gNB according to an embodiment;

FIG. 4 illustrates a method for determining a time-domain position of a second signal monitoring occasion according to an embodiment;

FIG. 5 illustrates a maximum duration of a monitoring occasion according to an embodiment;

FIG. 6 illustrates time-domain positions of monitoring occasions according to an embodiment;

FIG. 7 illustrates time-domain positions of monitoring occasions according to an embodiment;

FIG. 8 illustrates a scenario of a group wake-up signal (WUS) according to an embodiment;

FIG. 9 illustrates a configuration of a UE according to an embodiment; and

FIG. 10 illustrates a configuration of a base station according to an embodiment.

### DETAILED DESCRIPTION

The following description with reference to the accompanying drawings is provided to assist in a comprehensive understanding of various embodiments of the disclosure. It includes various specific details to assist in that understanding but these are to be regarded as examples. Accordingly, those of ordinary skill in the art will recognize that various changes and modifications of the various embodiments described herein can be made without departing from the scope and spirit of the disclosure. Descriptions of well-known functions and constructions may be omitted for the sake of clarity and conciseness.

The terms and words used in the following description and claims are not limited to the bibliographical meanings, but are merely used by the inventor to enable a clear and consistent understanding of the disclosure. Accordingly, the following description of embodiments of the disclosure is provided for illustration purposes only and not for limiting the disclosure.

The singular forms “a,” “an,” and “the” include plural forms unless the context clearly dictates otherwise. Thus, reference to “a component surface” includes reference to one or more of such surfaces.

The terms “include” or “may include” refer to the existence of a corresponding disclosed function, operation or component which can be used herein and do not limit one or more additional functions, operations, or components. Terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used herein includes any or all of combinations of listed words. For example, the expression “A or B” may include A, B, or both A and B.

Unless defined differently, all terms used herein, which include technical terminologies or scientific terminologies, have the same meaning as that understood by a person skilled in the art to which the disclosure pertains. Such terms as those defined in a generally used dictionary are to be interpreted to have the meanings equal to the contextual meanings in the relevant field of art and are not to be interpreted to have ideal or excessively formal meanings unless clearly defined herein.

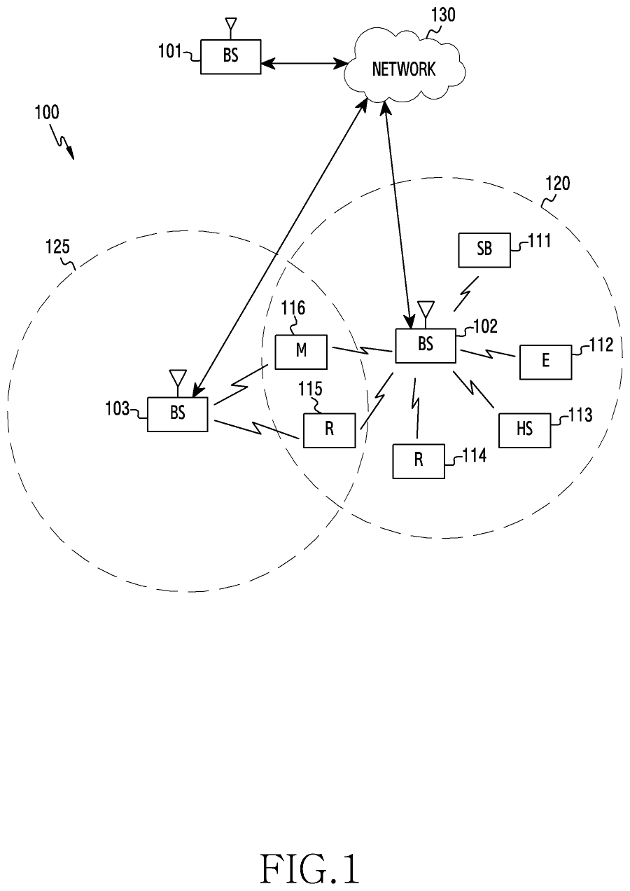

FIG. 1 illustrates a wireless network 100 according to an embodiment.

Referring to FIG. 1, the wireless network 100 includes a gNodeB (gNB) 101, a gNB 102, and a gNB 103. The gNB 101 communicates with gNB 102 and gNB 103 and also communicates with at least one Internet protocol (IP) network 130, such as the Internet, a private IP network, or other data networks.

Depending on the network type, other well-known terms such as base station or access point can be used instead of gNodeB or gNB. For convenience, the terms gNodeB and gNB are used in this patent document to refer to network infrastructure components that provide wireless access for remote terminals. and, depending on the type of the network, other well-known terms such as mobile station, user station, remote terminal, wireless terminal or user apparatus can be used instead of user equipment or UE. For convenience, the terms user equipment and UE are used herein to refer to remote wireless devices that wirelessly access the gNB, regardless of whether the UE is a mobile device (such as a mobile phone or a smart phone) or a fixed device (such as a desktop computer or a vending machine).

The gNB 102 provides wireless broadband access to the network 130 for a first plurality of UEs within a coverage area 120 of gNB 102. The first plurality of UEs include a UE which may be located in a small business (SB) 111, a UE 112, which may be located in an enterprise (E), a UE which may be located in a wireless fidelity (WiFi) hotspot (HS) 113, a UE which may be located in a first residence (R) 114, a UE which may be located in a second residence (R) 115, a UE 116, which may be a mobile device (M) 116, such as a cellular phone, a wireless laptop computer, a wireless personal data assistant (PDA), etc. The gNB 103 provides wireless broadband access to network 130 for a second plurality of UEs within a coverage area 125 of gNB 103. The second plurality of UEs include a UE in the R 115 and a UE in the M 116. One or more of gNBs 101-103 can communicate with each other and with UEs in locations 111-116 using 5G, long term evolution (LTE), LTE-advanced (LTE-A), WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

One or more of gNB 101, gNB 102, and gNB 103 include a 2D antenna array as described in embodiments of the present disclosure. One or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. The gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

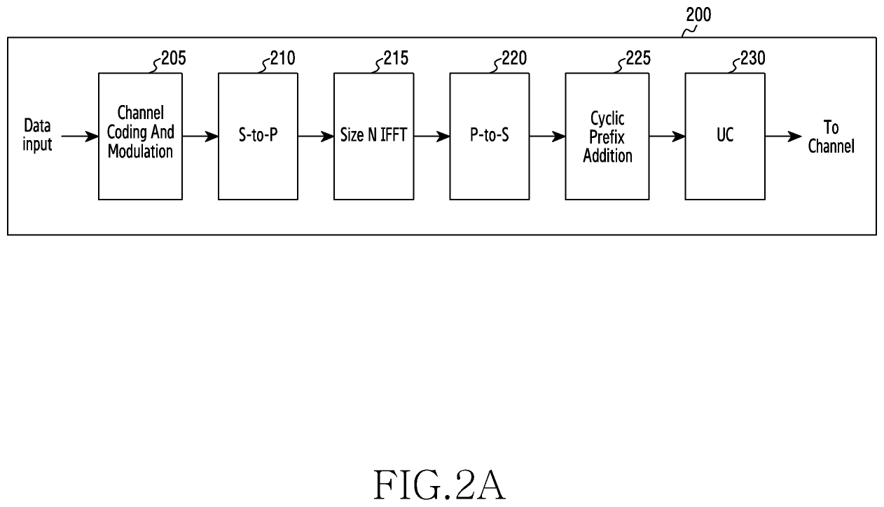

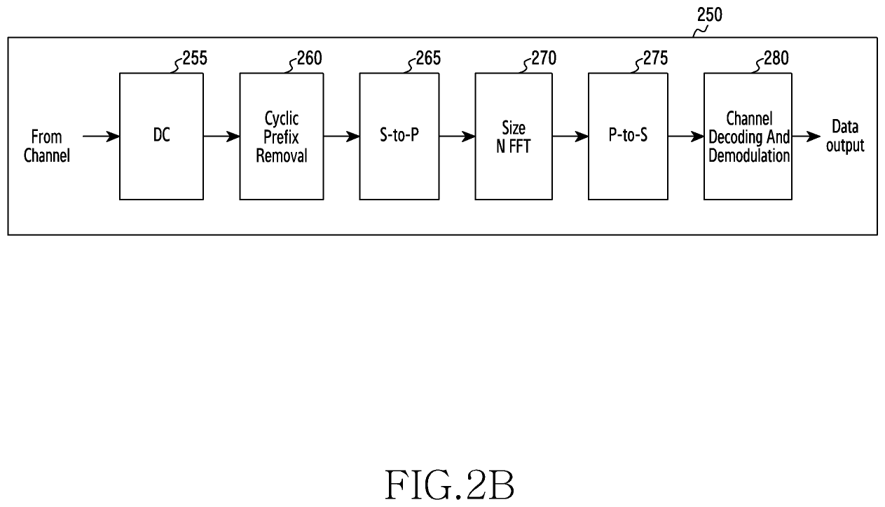

FIG. 2A illustrates a wireless transmission path according to an embodiment. FIG. 2B illustrates a wireless reception path according to an embodiment. Herein, the transmission path 200 is implemented in a gNB, such as gNB 102, and the reception path 250 is described as being implemented in a UE, such as UE 116. However, the reception path 250 can be implemented in a gNB and the transmission path 200 can be implemented in a UE. The reception path 250 is configured to support codebook designs and structures for systems with 2D antenna arrays as described herein.

Referring to FIG. 2A, the transmission path 200 includes a channel coding and modulation block 205, a serial-to-parallel (S-to-P) block 210, a size N inverse fast Fourier transform (IFFT) block 215, a parallel-to-serial (P-to-S) block 220, a cyclic prefix (CP) addition block 225, and an up-converter (UC) 230.

Referring to FIG. 2B, the reception path 250 includes a down-converter (DC) 255, a CP removal block 260, an S-to-P block 265, a size N fast Fourier transform (FFT) block 270, a P-to-S block 275, and a channel decoding and demodulation block 280.

In the transmission path 200, the channel coding and modulation block 205 receives a set of information bits, applies coding such as LDPC coding, and modulates the input bits such as using quadrature phase shift keying (QPSK) or QAM to generate a sequence of frequency-domain modulated symbols. The S-to-P block 210 demultiplexes serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The P-to-S block 220 multiplexes parallel time-domain output symbols from the size N IFFT block 215 to generate a serial time-domain signal. The CP addition block 225 inserts a CP into the time-domain signal. The up-converter 230 up-converts the output of the CP addition block 225 to an radio frequency (RF) for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the CP removal block 260 removes the CP to generate a serial time-domain baseband signal. The S-to-P block 265 converts the time-domain baseband signal into a parallel time-domain signal. The size N FFT block 270 performs an FFT algorithm to generate N parallel frequency-domain signals. The P-to-S block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink and may implement a reception path 250 similar to that for receiving from UEs 111-116 in the uplink. Similarly, each of UEs 111-116 may implement a transmission path 200 for transmitting to gNBs 101-103 in the uplink and may implement a reception path 250 for receiving from gNBs 101-103 in the downlink.

Each of the components in FIGS. 2A and 2B can be implemented using only hardware or a combination of hardware and software/firmware. For example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Although described as using FFT and IFFT, this is only illustrative and should not be interpreted as limiting the scope of the present disclosure. Other types of transforms can be used, such as discrete Fourier transform (DFT) and inverse DFT (IDFT) functions, for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. FIGS. 2A and 2B illustrate examples of types of transmission and reception paths that can be used in a wireless network. Any other suitable architecture can be used to support wireless communication in a wireless network.

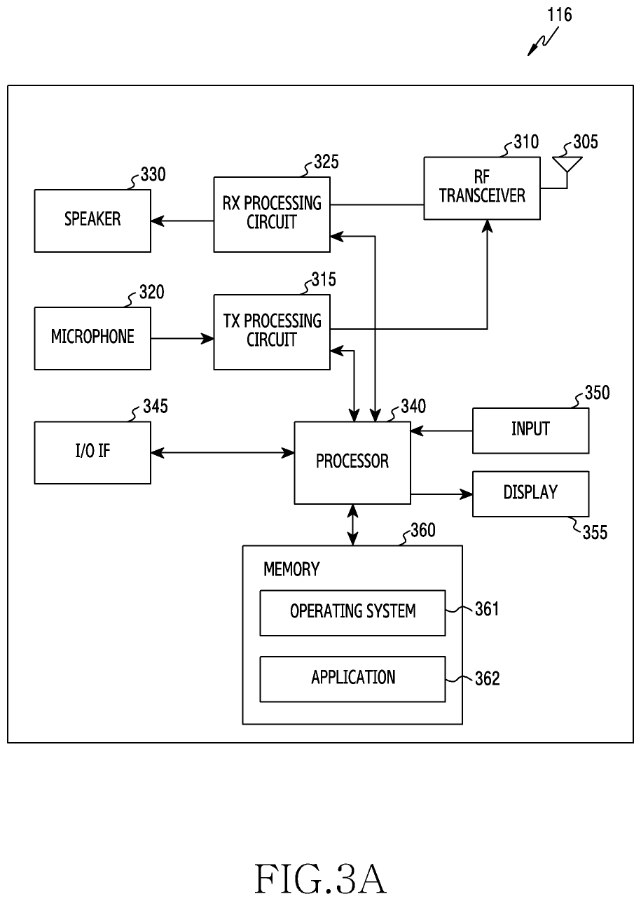

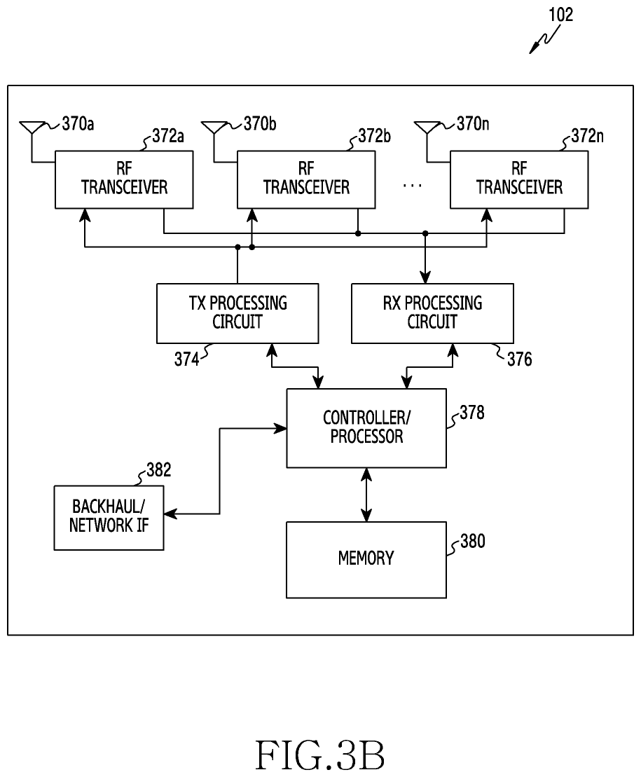

FIG. 3A illustrates a UE 116 according to an embodiment.

Referring to FIG. 3A, the UE 116 includes an antenna 305, a radio frequency (RF) transceiver 310, a transmission (TX) processing circuit 315, a microphone 320, a reception (RX) processing circuit 325, a speaker 330, a processor/controller 340, an input/output (I/O) interface 345, an input device(s) 350, a display 355, and a memory 360 including an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing, such as for web browsing data.

The TX processing circuit 315 receives analog or digital voice data from microphone 320 or other outgoing baseband data, such as network data, email or interactive video game data, from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. The processor/controller 340 includes at least one microprocessor or microcontroller.

The processor/controller 340 is also capable of executing other processes and programs residing in the memory 360, such as operations for channel quality measurement and reporting for systems with 2D antenna arrays as described herein. The processor/controller 340 can move data into or out of the memory 360 as required by an execution process. The processor/controller 340 is configured to execute the application 362 based on the OS 361 or in response to signals received from the gNB or the operator. The processor/controller 340 is also coupled to the I/O interface 345 which provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or another display capable of presenting text and/or at least limited graphics, such as from a website. The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components can be combined, further subdivided or omitted, and additional components can be added according to specific requirements. For example, the processor/controller 340 can be divided into a plurality of processors, such as one or more central processing units (CPUs) and one or more graphics processing units (GPUs). Although FIG. 3a illustrates that the UE 116 is configured as a mobile phone or a smart phone, UEs can be configured to operate as other types of mobile or fixed devices.

FIG. 3B illustrates an example gNB 102 according to an embodiment.

Referring to FIG. 3B, gNB 102 includes a plurality of antennas 370a-370n, a plurality of RF transceivers 372a-372n, a TX processing circuit 374, and a RX processing circuit 376. In certain embodiments, one or more of the plurality of antennas 370a-370n include a two-dimensional (2D) antenna array. The gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal that is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data, such as voice data, network data, email or interactive video game data, from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of the gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a blind interference sensing (BIS) process such as that performed through a BIS algorithm, and decode a received signal from which an interference signal is subtracted. A controller/processor 378 may support any of a variety of other functions in gNB 102. The controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described herein. The controller/processor 378 supports communication between entities such as web real time communications (RTCs). The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include a RAM, while another part of the memory 380 can include a flash memory or other ROMs. A plurality of instructions, such as the BIS algorithm, are stored in the memory and are configured to cause the controller/processor 378 to execute the BIS process and decode the received signal after subtracting at least one interference signal determined by the BIS algorithm.

The transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3a. For example, the access point can include many backhaul or network interfaces 382, and the controller/processor 378 can support routing functions to route data between different network addresses. Although shown as including a single instance of the TX processing circuit 374 and a single instance of the RX processing circuit 376, gNB 102 can include one for each RF transceiver.

A method and apparatus for low power wake up signal (LPWUS) configuration and monitoring will now be described. The LPWUS is used as an example, and the described method can also be used for configuration and transmission of other signals.

The receiver of the UE contains two modules, one being a main radio (MR) for receiving regular signals/channels transmitted by a base station, and the other being a lower power wake up receiver (LPWUR) for receiving the first signal transmitted by the base station The first signal is received using the dedicated module because the LPWUS is a waveform further based on amplitude shift keying (ASK) modulation and/or frequency shift keying (FSK) modulation based on OFDM waveform using existing NR systems. The LPWUR can monitor the first signal with extremely low power, and can trigger the MR to transition from dormant time to active time, so that specific operations can be performed. On-off keying (OOK) modulation is a special case of ASK modulation. The first signal may be used for synchronization and/or RRM measurements and may include at least one of LPWUS and/or low power synchronization signal (LP-SS) for synchronization and/or synchronization signal block (SSB) and/or primary synchronization signal (PSS) and/or secondary synchronization signal (SSS) and/or PBCH demodulation reference signal (DMRS) and/or tracking reference signal (TRS). The second signal may be a signal for waking up the UE, such as an LPWUS. The first signal and the second signal may each be a wake up signal.

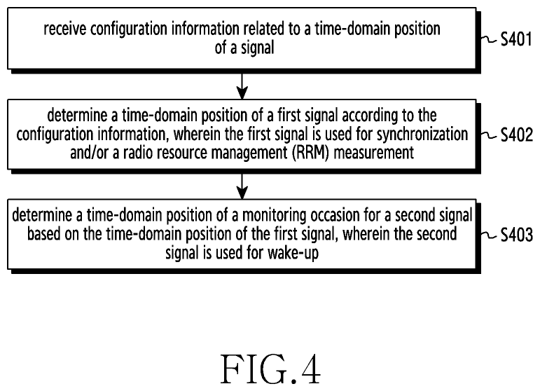

FIG. 4 illustrates a method for determining a time-domain position of a second signal monitoring occasion according to an embodiment. Referring to FIG. 4, at step S401, configuration information related to a time-domain position of a signal is received. At step S402, according to the configuration information, a time-domain position of a first signal is determined, wherein the first signal is used for synchronization and/or an RRM measurement. At step S403, based on the time-domain position of the first signal, a time-domain position of a monitoring occasion for a second signal is determined, wherein the second signal is used for wake-up.

The UE may use the second signal to reduce power overhead. The UE acquires the configuration information for the first signal and/or the second signal by receiving an RRC message and/or a higher layer parameter. If the configuration information for the first signal and/or the second signal is provided by the RRC message and/or the higher layer parameter, the UE supporting the first signal and/or the second signal may monitor the first signal and/or the second signal according to the configuration parameter configured in the RRC message and/or the higher layer parameter. In an RRC INACTIVE and/or IDLE state, the first signal and/or the second signal may be configured in a system information block (SIB), a master information block (MIB), and/or small data transmission (SDT). In the RRC IDLE state, the first signal and/or the second signal may be configured in the higher layer parameter. The configuration information for the first signal and/or second signal or a second signal resource or a set of second signal resources includes a maximum duration of the second signal or second signal monitoring occasion. A duration of the second signal or second signal monitoring occasion may be less than a configured maximum duration of the second signal or second signal monitoring occasion. The granularity of the configured maximum duration is the same as the granularity of the associated PO and may be an OFDM symbol or a slot or a subframe; A method for determining the maximum duration may be a combination of one or more of:
the maximum duration is denoted as a ratio of the duration of “S*X” consecutive PDCCH monitoring occasions, where “S” is a number of actually transmitted SSBs determined from ssb-PositionsInBurst in SIB1 and X is a number of PDCCH monitoring occasions corresponding to an SSB within one paging occasion;
a value of the maximum duration may be at least one of: ¼, ⅛, 1/16, 1/32, 1/64, i.e. ½^{N}; Nis a real number. Such a configuration method may ensure that the configured maximum duration is more than one consecutive slots;
the UE determines the maximum duration of the second signal or the second signal monitoring occasion according to the configured maximum duration, which may be the maximum of the configured maximum duration and 1 time unit. The time unit may be a slot or a subframe.

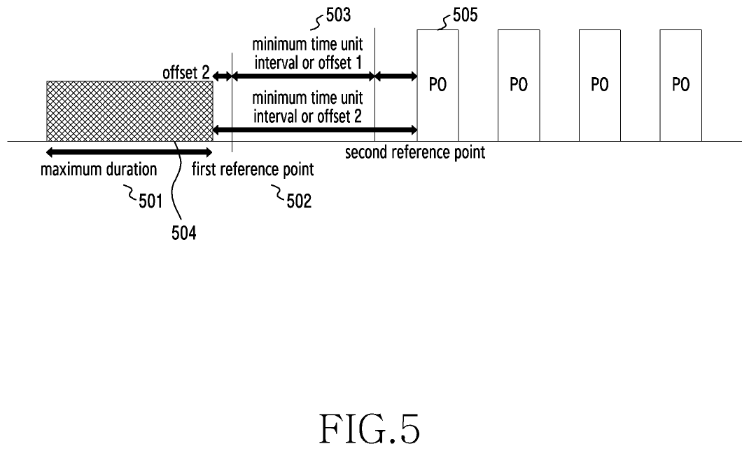

FIG. 5 illustrates a maximum duration of a monitoring occasion according to an embodiment.

Referring to FIG. 5, a minimum time unit interval or offset 1 (503) from the first reference point 501 where the end point of the second signal or second signal monitoring occasion is located to the second reference point 502 is shown. The minimum time unit interval should be large enough to ensure that the MR of the UE can be waked up. The value of the minimum time unit interval may be configured in the unit of milliseconds (ms) and may include at least one of 400 ms, 800 ms, 1.6 s, 3.2 s, or 4.8 s.

Alternatively, the value of the minimum time unit interval may be the number of radio frames or system frame numbers (SFNs). The minimum time unit interval may be configured as a short time interval whose value may include at least one of 400 ms or 40 radio frames, 800 ms or 80 radio frames, 1.6 s or 160 radio frames, 3.2 s or 320 radio frames, 4.8 s or 480 radio frames. The minimum time unit interval is fixed to C when there is no UE capability to be reported. C may be one of the values of the minimum time unit interval, optionally C=400 ms or C is 40 radio frames. The UE reports a UE capability whose value may include at least one of 400 ms or 40 radio frames, 4.8 s or 480 radio frames. For extended DRX, the minimum time unit interval may be configured as a long time interval whose value may be 10.24 s*q or q SFNs. q may be a parameter value (pre) configured by the base station device or predefined and/or reported by the UE according to processing capability of the UE. q is a natural number and q is greater than or equal to 1. Optionally, q=1 and/or q=2.

The first reference point 501 may be the end point of the radio frame or the end point of the subframe or the end point of the slot or the end point of the SFN or the end point of the OFDM symbol where the end point of the second signal or the second signal monitoring occasion is located, as shown by minimum time unit interval or offset 2 (504) in FIG. 5. The end point of the second signal or second signal monitoring occasion may be an end point of a maximum duration of the second signal or the second signal monitoring occasion. If the end point of the second signal or second signal monitoring occasion is different from the end point of the maximum duration, and/or if the granularity of the minimum time unit interval or offset is different from the granularity of the maximum duration, such as if the granularity of the minimum time unit interval or offset is a radio frame or SFN and the granularity of the maximum duration of the second signal or second signal monitoring occasion is an OFDM symbol or a slot or a subframe, this indicates that the interval or offset from the end point of the maximum duration of the second signal or second signal monitoring occasion to the first reference point is not 0, which may be configured by an RRC message and/or a higher layer parameter or SIB, as shown by offset 2 (504) in FIG. 5. The first reference point may be determined by the end point of the maximum duration of the second signal or the second signal monitoring occasion, and the interval or offset from the end point of the maximum duration of the second signal or the second signal monitoring occasion to the first reference point 501. The maximum duration end point of the second signal or second signal monitoring occasion may be determined by the second reference point, the configured interval or offset from the maximum duration end point of the second signal or second signal monitoring occasion to the first reference point, and the configured minimum time unit interval or offset, as shown by offset 2 (504) and a minimum time unit interval or offset 1 (503) in FIG. 5.

If the end point of the second signal or second signal monitoring occasion is the same as the end point of the maximum duration, and/or if the granularity of the minimum time unit interval or offset is the same as the granularity of the maximum duration, such as if the granularity of the minimum time unit interval or offset is a radio frame or SFN and the granularity of the maximum duration of the second signal or second signal monitoring occasion is a radio frame or SFN, the first reference point 501 may be the end point of the maximum duration of the second signal or second signal monitoring occasion, and the maximum duration end point of the second signal or second signal monitoring occasion may be determined by the second reference point 502 and the minimum time unit interval or offset.

The second reference point 502 may be the start point of the first paging frame in the paging frame associated with the second signal or the second signal monitoring occasion, or the start point of the SFN where the paging frame associated with the second signal or the second signal monitoring occasion is located, as shown by a minimum time unit interval or offset 1 (503). This method for start point determining applies to when the granularity of the minimum time unit interval or offset is the SFN or the radio frame.

Alternatively, the second reference point 502 may be the start point of the slot, the start point of the subframe, or the start point of the OFDM symbol where the start point of the first associated PO in the first paging frame associated with the second signal or the second signal monitoring occasion is located, as shown by a minimum time unit interval or offset 2 (504). This method for start point determining may minimize additional resource waste due to the difference between the minimum time required actually for the MR to transition from the ultra-low sleep state to the awake state and the configured minimum time interval.

The start point of the first associated PO 505 may be determined by an ID of the paging search space. When the ID of the paging search space is equal to 0, if a PO is included in a paging frame, the start point of the first associated PO 505 is the start point of the time unit where the first PDCCH monitoring occasion for paging is located. When the ID of the paging search space is equal to 0, if two POs are included in a paging frame, the start point of the first associated PO is the start point of the paging frame where the PO is located or the start point of the second half of the paging frame where the PO is located, that is, the start point of the subframe with subframe index 5 in the paging frame. When the ID of the paging search space is not equal to 0, the start point of the first associated PO is the current PO index plus the start point of the time unit where 1 PO is located.

The granularity of the minimum time interval or offset may be a slot or subframe or radio frame and/or SFN. Alternatively, when the granularity of the minimum time interval or offset is the SFN or radio frame, the interval or offset from the end point of the maximum duration of the second signal or the second signal monitoring occasion to the first reference point is not 0.

The configuration information for the first signal or a first signal resource or a set of first signal resources includes a maximum number of consecutive DRX cycles for which the UE can use the first signal for synchronization and skip serving cell measurements; within the DRX cycle, the UE does not perform RRM measurements and/or the UE does not monitor the SSB and the first signal. The configuration information further includes a set of first signals to be measured within the maximum duration. If this field is not configured, the UE measures all first signals configured within the maximum duration. Also included in the configuration information is a cycle of the first signal.

The minimum time unit interval or offset is predefined or (pre) configured by higher layer parameters and/or RRC parameters. The minimum time unit interval may be determined by a predefined or (pre) configured short time interval if a long time interval is not configured or not broadcasted. The minimum time unit interval is equal to the short time interval. The configured minimum time unit interval is greater than or equal to the minimum time unit interval reported by the UE.

If a long time interval is configured or broadcasted, or both the short time interval and the long time interval are configured, and/or when the UE reports one or more UE capabilities from end of the maximum duration of the first signal to the minimum time unit interval of the first associated PO, the minimum time unit interval may be determined as follows:
If the configured minimum time unit interval is equal to the minimum time unit interval reported by the UE, the minimum time unit interval is equal to the configured minimum time unit interval.
The minimum time unit interval may be determined according to the (pre) configured or predefined short time interval if the UE does not report the minimum time unit interval or the reported minimum time unit interval is one or more of short unit intervals. The configured minimum time unit interval is greater than or equal to the minimum time unit interval reported by the UE, ensuring that the UE can wake up the MR to monitor PO and/or receive paging and/or establish an RRC link within the configured short time interval.
If the configured minimum time unit interval is less than the minimum time unit interval reported by the UE, the UE monitors the second signal using a configured short time interval, i.e. the minimum time unit interval is equal to the configured short time interval. If the configured minimum time unit interval is less than a maximum of more than one minimum time unit intervals reported by more than one UEs in a UE group, the UE monitors the second signal using a configured short time interval. The configured minimum time unit interval and/or the minimum time unit interval reported by the UE is a long time interval. This method is performed since the UE capability reported by the UE cannot satisfy the configuration of the network, so the UE more rapidly determines the minimum time unit interval using the configured short time interval to wake up the MR.
If the configured minimum time unit interval is less than the minimum time unit interval reported by the UE, or if the configured minimum time unit interval is less than a maximum of more than one minimum time unit intervals reported by more than one UEs in a UE group, the UE uses the minimum time unit interval reported by the UE. This method is performed to ensure that the UE with the worst UE capability may have sufficient time to wake up to monitor PO and/or receive paging and/or establish an RRC link.
If the minimum configured time unit interval is greater than the minimum time unit interval reported by the UE, the UE monitors the second signal using a configured long time interval, i.e. the minimum time unit interval is equal to the configured long time interval. This method further satisfies the expectations of the network as to satisfying the UE capabilities.

Alternatively, since the cycle of the first signal is long, if the second signal monitoring occasion is far from the first signal, correct reception of the second signal is not guaranteed at the LPWUR (LR) of the UE.

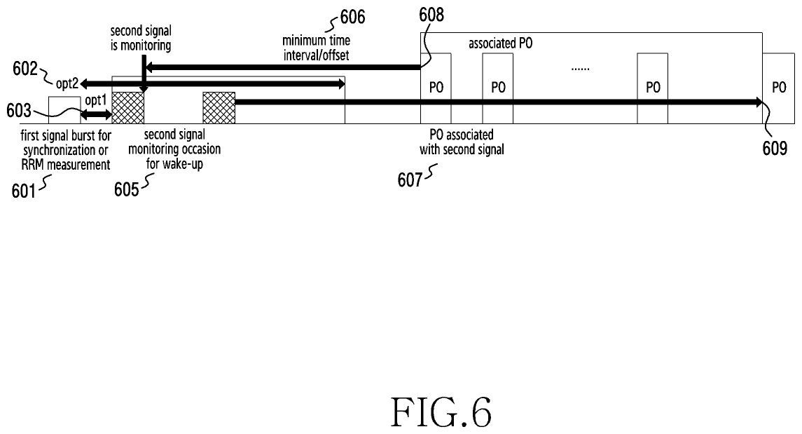

FIG. 6 illustrates time-domain positions of monitoring occasions according to an embodiment.

Referring to FIG. 6, to reduce the error alarm rate and the false alarm rate of the second signal monitoring, the time-domain position of the second signal monitoring occasion may be determined as follows:
The time-domain OFDM symbol or slot start point of the second signal monitoring occasion for wake-up 605 is determined according to the OFDM symbol or slot end or start point of the first signal or first signal burst 601 and a preconfigured or predefined first offset, the granularity of which may be an OFDM symbol or slot, as shown at opt1 (603). This method ensures that the time-frequency offset 606 of the received second signal is within a certain range, so that the second signal can be correctly received.
The time-domain OFDM symbol or slot end point of the second signal monitoring occasion for wake-up 605 is determined according to the OFDM symbol or slot end or start point of the first signal or first signal burst 601 and a preconfigured or predefined second offset, the granularity of which may be OFDM symbol or slot, as shown at opt2 (602). This method ensures that the last second signal or repetition of the second signal received by the UE is still within the second signal time-frequency offset acceptable to the UE.

In the second signal monitoring occasion for wake-up 605, one or more second signals may be configured, and the association of the second signals with the PO 607 may include the following:
Each second signal may be associated to at most K consecutive POs, and the start point of the first PO associated with a second signal 607 may be determined by the end point of the i-th second signal and the configured minimum time unit interval or offset, and The start point of the first PO 608 closest to the end point of the i-th second signal plus the configured minimum time unit interval or offset is the start point of the first PO associated with the i-th second signal 607, where i is a real number greater than or equal to 1.
The second signal in the second signal monitoring occasion for wake-up 605 may be associated to all POs starting with the start point of the first PO after the minimum time unit interval and ending with the start point of the first PO 609 associated with the next first signal monitoring occasion, from the end point of the second signal monitoring occasion, as shown in FIG. 6. A second signal may be configured to wake up the UE to monitor all the POs, and/or more than one first signals may be configured in a second signal monitoring occasion. Each second signal may be associated to L consecutive POs, e.g., a 1st second signal monitored in a second signal monitoring occasion may be associated to a start of the first PO to an end of an L-th PO, a 2nd second signal may be associated to a start of an (L+1)-th PO to an end of a 2L-th PO, and so on.
The K and L values may be parameter values reported by the UE according to its own processing capability and/or parameter values configured by the base station that are received by the UE and/or preconfigured parameter values and/or predefined parameter values. K and L are real numbers greater than 0.

The second signal monitoring occasion for wake-up 605 may be used to monitor a second signal when a reference signal receiving power (RSRP) of the first signal is greater than or equal to a predefined or preconfigured first threshold value and/or a reference signal receiving quality (RSRQ) is greater than or equal to a predefined or preconfigured second threshold value, or when a cell selection RX level value (Srxlev) calculated by the RSRP obtained by the UE based on the first signal measurement is greater than or equal to a predefined or (pre) configured third threshold value and/or a cell selection quality value calculated by the RSRQ obtained by the UE based on the first signal measurement is greater than or equal to a predefined or (pre) configured fourth threshold value.

Alternatively, the network may page other UEs in the same UE group within the start time of the one or more UEs waked up by the current second signal due to the long start time for the UE to transition from the ultra-low deep sleep state to the awake state.

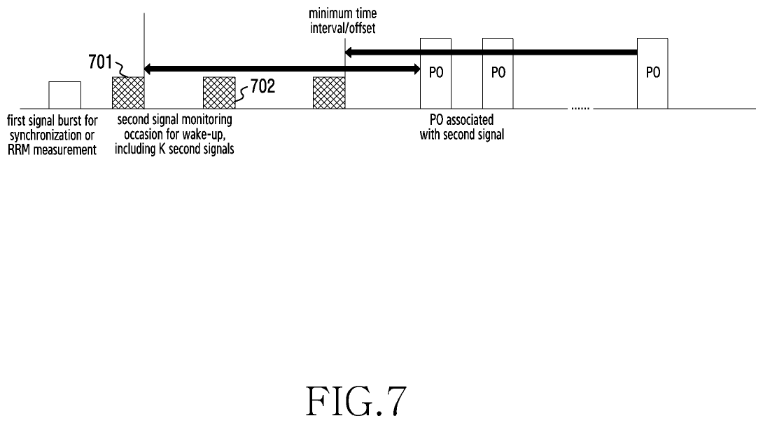

FIG. 7 illustrates time-domain positions of monitoring occasions according to an embodiment.

Referring to FIG. 7, to reduce the latency for the UE to receive the paging message, the second signal monitoring occasion for wake-up 701 may be periodically configured. If the UE receives the second signal and the second signal wakes up the corresponding UE, the UE no longer monitors the subsequent second signal monitoring occasion, and the UE is waked up to monitor the associated POs that satisfy the minimum time unit interval, which are all POs starting with the start point of the first PO satisfying the minimum time unit interval and ending with the start point of the first PO associated with the next second signal monitoring occasion 702, from the end point of the second signal monitoring occasion. If the UE does not receive a paging message on the PO or the paging message received by the UE does not indicate that the UE establishes an RRC connection, the UE re-enters the ultra-low sleep state and periodically monitors a second signal monitoring occasion for wake-up.

An example of the UE behavior in the event of a collision is as follows.

The resource mapping method and/or transmission method of the first signal and/or the second signal may include a combination of one or more of:
time units satisfying the first condition shall not be used for the first signal and/or the second signal transmission but is counted in the mapping process of the first signal and/or the second signal; The first signal and/or the second signal satisfying the first condition is a repeatedly transmitted first signal and/or second signal. The reason for using the method is that other signals overlapping or colliding with the first signal and/or the second signal are more important in the first condition;
time units satisfying the first condition shall not be used for the first signal and/or the second signal transmission and is not counted in the mapping process of the first signal and/or the second signal; The first signal and/or the second signal satisfying the first condition is a repeatedly transmitted first signal and/or second signal. The reason for using the method is that other signals overlapping or colliding with the first signal and/or the second signal are more important in the first condition;
when the first condition is satisfied, the first signal and/or the second signal time unit is dropped, optionally the time unit in which the first signal and/or the second signal is located is dropped; The first signal and/or the second signal satisfying the first condition is a repeatedly transmitted first signal and/or second signal. The reason for using the method is that other signals overlapping or colliding with the first signal and/or the second signal are more important in the first condition;
when the first condition is satisfied, the first signal and/or the second signal time unit is received, i.e. shall be used for the first signal and/or the second signal transmission in the mapping process of the first signal and/or the second signal; The first signal and/or the second signal satisfying the first condition is not a repeatedly transmitted first signal and/or second signal. The reason for using the method is that the transmission of the first signal and/or the second signal is more important;

The first condition may include a combination of one or more of:
any time unit and/or frequency-domain unit in which the first signal and/or second signal is located overlaps or collides with any time unit and/or frequency-domain unit in which the first downlink signal is located;
any time unit and/or frequency-domain unit of the guard band in which the first signal and/or second signal is located overlaps or collides with any time unit and/or frequency-domain unit in which the first downlink signal is located;
any time unit and/or frequency-domain unit in a frequency band or carrier allocated for the first signal and/or the second signal overlaps or collides with any time unit and/or frequency-domain unit in which the first downlink signal is located;
the first downlink signal includes at least one of an SSB, system information (SI) message, PSS, SSS, RSS, PBCH, LP-SS, LPWUS, control resource set (CORESET), CORESETO, PDCCH and/or physical downlink shared channel (PDSCH) scheduling and/or transmitting SIB, PDCCH and/or PDSCH scheduling and/or transmitting control resource set 0 CORESETO, PDCCH and/or PDSCH scheduling and/or transmitting message 2 (MSG2)/message B MSGB, PDCCH and/or PDSCH scheduling and/or transmitting paging, and PDCCH and/or PDSCH scheduling and/or transmitting downlink small data transmission DL SDT signal, and positioning reference signal (PRS).

The slots that the UE does not expect for transmission of the first signal and/or the second signal are indicated as uplink or overlap with uplink symbols determined according to the configuration. The second signals that do not overlap with the uplink symbols determined according to the configuration are numbered sequentially starting from zero from the second signal monitoring occasion.

If the slots for the transmission of the first signal and/or the second signal are indicated as uplink or overlap with uplink symbols determined according to the configuration, resources corresponding to the overlapped time units are not valid first signal and/or second signal resources.

When the first signal and/or the second signal overlaps or collides with the UL signal in all or part of the time and/or frequency-domain units, the behavior of the UE may include a combination of one or more of:
if an overlap or collision on any time unit and/or frequency-domain unit occurs between any time unit and/or frequency-domain unit in which the first signal and/or the second signal and/or the first/second signal including the guard band is transmitted with a physical random access channel (PRACH)-related signal (such as MSG1 and/or MSG3 and/or MSG A) or a predefined or preconfigured time unit interval before and/or after the PRACH-related signal, the time unit and/or frequency-domain unit in which the overlap or collision occurs is not a valid first signal and/or second signal resource, and/or the UE expects to transmit the PRACH-related signal, such as MSG1 and/or MSG3 and/or MSG A, and the UE does not expect to receive or monitor the first signal and/or second signal. Optionally, when the second signal is used to wake up a group of UEs, the UE expects to transmit the PRACH-related signal such as MSG1 and/or MSG3 and/or MSG A, and does not expect to receive or monitor the second signal. The reason for using the operation is that the PRACH-related signal is more important than the second signal, especially when the second signal is a repeatedly transmitted second signal.
if an overlap or collision on any time unit and/or frequency-domain unit occurs between any time unit and/or frequency-domain unit in which the second signal and/or the second signal including the guard band is transmitted with a PRACH-related signal (such as MSG1 and/or MSG3 and/or MSG A) or a predefined or preconfigured time unit interval before and/or after the PRACH-related signal, when the second signal is used to wake up a group of UEs, the UE expects to receive or monitor the second signal, and the UE does not expect to transmit the PRACH-related signal, such as MSG1 and/or MSG3 and/or MSG A. The reason for using the operation is that the second signal is used to wake up one or more UEs of a group of UEs, and if the second signal is dropped, the wake up signal of the group of UEs will be missed, and at this time, receiving the second signal of the group of UEs is considered to be more important than a UE transmitting the PRACH.
if an overlap or collision on any time unit and/or frequency-domain unit occurs between any time unit and/or frequency-domain unit in which the first signal and/or the second signal and/or the first/second signal including the guard band is transmitted with a sounding reference signal (SRS), when the first signal is used to wake up a group of UEs, the UE expects to receive or monitor the first signal and/or the second signal, and the UE does not expect to transmit the SRS. The reason for using the operation is that receiving the first signal and/or the second signal of a group of UEs is more important than a UE transmitting SRS.
if an overlap or collision on any time unit and/or frequency-domain unit occurs between any time unit and/or frequency-domain unit in which the first signal and/or the second signal and/or the first/second signal including the guard band is transmitted with the SRS, any time unit and/or frequency-domain unit in which the overlap or collision occurs is not a valid first signal and/or second signal resource, and/or the UE transmits the SRS, and the UE does not expect to receive or monitor the first signal and/or the second signal. Such an operation applies when the first signal and/or the second signal is a repeatedly transmitted first signal and/or second signal.
if an overlap or collision on any time unit and/or frequency-domain unit occurs between any time unit and/or frequency-domain unit in which the second signal and/or the second signal including the guard band is transmitted with the UL SDT, when the second signal is used to wake up a group of UEs, the UE does not transmit the UL SDT and/or the UE expects to receive or monitor the second signal. At this time, although the UE transmitting the SDT no longer needs to receive or monitor the second signal, since the second signal is used to wake up one or more UEs of a group of UEs, receiving the second signal of the group of UEs is considered to be more important than a UE transmitting the UL SDT.
if an overlap or collision on any time unit and/or frequency-domain unit occurs between any time unit and/or frequency-domain unit in which the first signal and/or the second signal and/or the first/second signal including the guard band is transmitted with the UL SDT, any time unit and/or frequency-domain unit in which the overlap or collision occurs is not a valid first signal and/or second signal resource, the UE does not expect to receive or monitor the first signal and/or the second signal, and/or the UE expects to transmit the UL SDT. Such an operation applies when the first signal and/or the second signal is a repeatedly transmitted first signal and/or second signal.

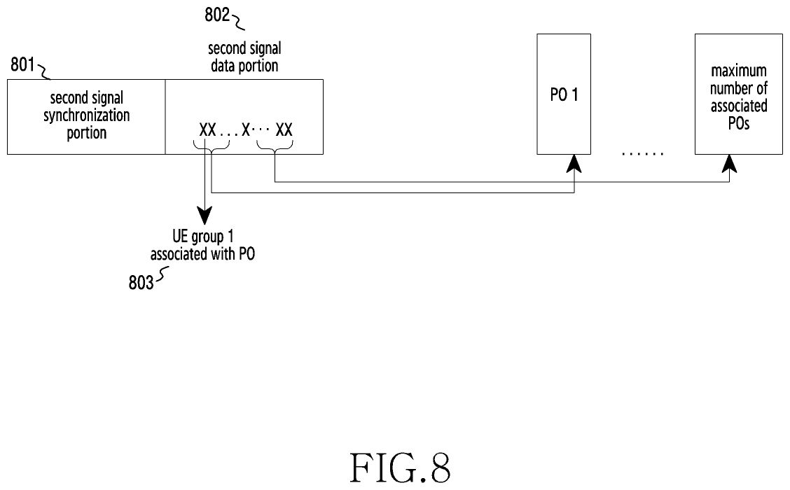

FIG. 8 illustrates a scenario of a group WUS according to an embodiment.

Referring to FIG. 8, the second signal for wake-up may include a synchronization portion 801 and a data portion 802. The synchronization portion 801 may be used to further reduce the impact of time-frequency and phase offset, and the data portion 802 may carry partial UE group-specific indication information. The common second signal is a special embodiment of a second signal that can be used to wake up UEs or more than one group of UEs in the entire cell.

The method for grouping UEs of the second signal may include subgroups specified by a core network and/or grouping based on a UE index.

As to subgroups specified by a core network, the UE is assigned a subgroup index (between 0 and 7) based on NAS signaling from an AMF. Based on the determined association between the second signal and subgroup index, the second signal indicates the UE belonging to the subgroup index to monitor its related PO.

As to grouping based on UE index, the subgroup index of the UE is implicitly indicated and is equal to (floor (UE_ID/(N*Ns)) mod subgroupsNumForUEID)+(subgroupsNumPerPO−subgroupsNumForUEID), where floor represents the lower bound of rounding, UE_ID is equal to S-TMSI mod X, S-TMSI is the temporary UE identification number, X is a predefined value, Nis the total number of paging frames at duration T, Ns is the number of POs in a paging frame, subgroupsNumPerPO represents the number of subgroups grouped based on core network-specified grouping and based on UE_ID in a PO, and subgroupsNumForUEID represents the number of subgroups based on UE_ID in a PO. Based on the determined association between the second signal and subgroup index, the second signal indicates the UE belonging to the subgroup index to monitor its related PO. T is determined by the shortest value among the UE-specific DRX values, and T is a real number greater than 0.

The method for determining the association between the second signal and subgroup index may include the following:
The physical signal sequence generated for the second signal implies the UE subgroup index or the second signal resource index associated with the UE subgroup index; If there are more than one second signal resources, the association of each second signal resource with a UE subgroup may be configured by RRC signaling or higher layer signaling or SIB.
The length of the data of the second signal may be the number of POs associated with the second signal multiplied by the number of subgroups corresponding to each PO, where the data corresponds to a set of UE subgroup indices per bit, and the UEs in the UE subgroup 803 are waked up to monitor the associated PO when the information bit corresponding to the subgroup index indicates “1”. Otherwise, i.e. when the information bit corresponding to the subgroup index indicates “0”, the UEs in the UE subgroup do not monitor the associated PO, as shown in FIG. 8.

A UE supporting the second signal grouping may be configured to monitor the second signal and/or a common second signal. The common second signal corresponds to all UEs in the cell and is used to wake up all UEs in the cell. The common second signal may be determined in association with all associated UE subgroups on the PO, and is used to wake up all associated UE subgroups on the PO.

The common second signal may be determined as follows:
The physical signal sequence generated for the second signal implies the UE subgroup index. When the UE subgroup index is 0, this indicates that the generated second signal is the common second signal.
The second signal is the common second signal when the second signal does not include or is not configured with a data portion.

If the UE can support and is configured with a PEI and the second signal, the behavior of the UE may be as follows:
The UE only monitors the second signal and does not monitor the PEI. If the second signal supports the second signal grouping, the UE only monitors the second signal and does not monitor the PEI. The second signal indicates whether the UEs in the UE group need to be waked up to monitor the PO associated with the second signal, or directly establish an RRC connection.
If the second signal is the common second signal, and/or the second signal does not support UE grouping, the UE is waked up to monitor the PEI occasion and determines whether to be waked up to monitor the associated PO based on the PEI monitoring result. After the UE receives the common second signal and is waked up, the UE needs to monitor the PO associated with the second signal. There may be no UE-specific PDCCH to be transmitted, causing this monitoring method to incur additional power loss. If the UE continues to monitor the PEI occasion after receiving the common second signal and being waked up, the PEI may indicate whether the UE needs to monitor the corresponding PO, which may reduce the power consumption of the UE to monitor a PO that is not associated with PEI.

The UE assumes that no more than one second signal sequence (second signal or common second signal) is transmitted on each second signal resource at a given time. The behavior of the UE or the UE subgroup monitoring the second signal for wake-up may include the following:
When DRX or eDRX is used and the UE detects any one of the second signal and the common second signal, and/or the second signal indicates the subgroup to which the UE belongs to monitor its associated PO, the UE is waked up to monitor the next or associated PO.
If the UE or the UE group does not monitor the second signal or the second signal does not indicate the subgroup to which the UE belongs to monitor its associated PO, the UE's failure to monitor the second signal may be that the UE does not monitor the second signal for a maximum duration of the second signal or the second signal monitoring occasion. The UE or the UE group does not need to monitor one or more subsequent POs, and is not waked up or continues to be in an ultra-low sleep state or a deep sleep state.

When a second condition is satisfied, the MR of the UE may perform a serving cell RRM measurement and/or a neighboring cell RRM measurement and/or a camping cell RRM measurement through the RRC configured maximum number of consecutive DRX cycles in which the serving cell measurement is skipped or the relaxed RRM measurement cycle. The second condition may include

the relaxed RRM measurement being enabled/activated by the network, and/or the relaxed RRM measurement being disabled/deactivated by the network.

If the reference cell selection RX level value (Srxlev) of the serving cell based on the first signal or SSB minus the Srxlev calculated based on the RSRP of the first signal or SSB is less than or equal to a predefined or (pre) configured fifth threshold value, after cell selection or cell reselection to a new cell, if the Srxlev calculated based on the RSRP of the first signal or SSB minus the reference Srxlev of the serving cell based on the first signal or SSB is greater than or equal to 0, or if the relaxed monitoring principle is not satisfied for a predefined or preconfigured duration, the UE sets the reference Srxlev of the serving cell to the Srxlev calculated based on the RSRP of the first signal or SSB.

When the Srxlev calculated by the RSRP and/or RSRQ obtained by the UE based on the first signal or SSB measurement is greater than or equal to a predefined or (pre) configured sixth threshold value, when the cell selection quality value (Squal) calculated by the RSRP and/or RSRQ obtained by the UE based on the first signal or SSB measurement is greater than or equal to a predefined or (pre) configured seventh threshold value, when the RSRP obtained by the UE based on the first signal or SSB measurement is greater than or equal to a predefined or (pre) configured eighth threshold value, or when the RSRQ obtained by the UE based on the first signal or SSB measurement is greater than or equal to a predefined or (pre) configured ninth threshold value

In a preconfigured or predefined time unit, when a variation range of the RSRP by the UE based on the first signal or SSB measurement is less than or equal to a predefined or (pre) configured tenth threshold value, or when a variation range of the RSRQ by the UE based on the first signal or SSB measurement is less than or equal to a predefined or (pre) configured eleventh threshold value

When the relaxed RRM measurement is disabled/deactivated, the first signal may still be enabled or activated. The first signal may provide synchronization of timing/frequency offset due to unsynchronization of a maximum of num DRX cycles or POs for the MR, where num may be a parameter value that is fixed or configurable or determined according to the length of the DRX cycle or the length of the PTW, and num is a real number greater than 0, which may be a power of 2, and is configured by SIB or a cell-specific RRC message.

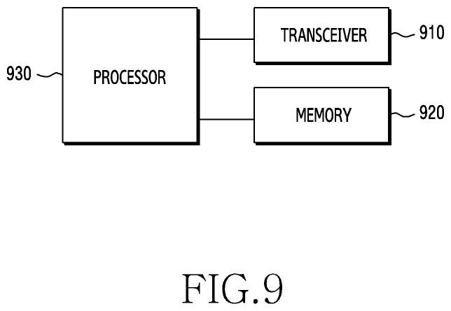

FIG. 9 illustrates a configuration of a UE 900 according to an embodiment.

Referring to FIG. 9, the UE may include a transceiver 910, a memory 920, and a processor 930, which may operate according to a communication method of the UE described herein. However, the components of the UE are not limited thereto. For example, the UE may include more or fewer components than those described above. In addition, the processor 930, the transceiver 910, and the memory 920 may be implemented as a single chip, and the processor 930 may include at least one processor.

The transceiver 910 collectively refers to a UE receiver and a UE transmitter and may transmit/receive a signal to/from a base station or a network entity. The signal transmitted or received to or from the base station or a network entity may include control information and data. The transceiver 910 may include an RF transmitter for up-converting and amplifying a frequency of a transmitted signal, and an RF receiver for amplifying low-noise and down-converting a frequency of a received signal. However, this is only an example of the transceiver 910 and components of the transceiver 910 are not limited to the RF transmitter and the RF receiver.

The transceiver 910 may receive and output, to the processor 930, a signal through a wireless channel, and transmit a signal output from the processor 930 through the wireless channel.

The memory 920 may store a program and data required for operations of the UE. The memory 920 may store control information or data included in a signal obtained by the UE. The memory 920 may be a storage medium, such as ROM, RAM, a hard disk, a CD-ROM, and a digital versatile disc (DVD), or a combination of storage media.

The processor 930 may control a series of processes such that the UE operates as described above. For example, the transceiver 910 may receive a data signal including a control signal transmitted by the base station or the network entity, and the processor 930 may determine a result of receiving the control signal and the data signal transmitted by the base station or the network entity.

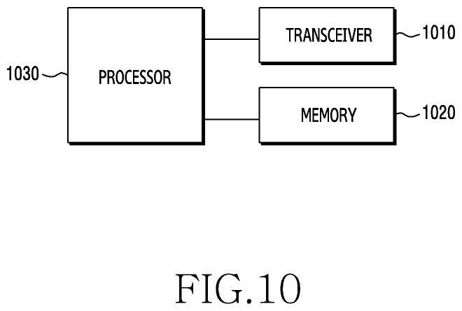

FIG. 10 illustrates a configuration of a base station 1000 according to an embodiment.

Referring to FIG. 10, the base station may include a transceiver 1010, a memory 1020, and a processor 1030. The transceiver 1010, the memory 1020, and the processor 1030 of the base station may operate according to a communication method of the base station described above. However, the components of the base station are not limited thereto. For example, the base station may include more or fewer components than those described above. the processor 1030, the transceiver 1010, and the memory 1020 may be implemented as a single chip. the processor 1030 may include at least one processor.

The transceiver 1010 collectively refers to a base station receiver and a base station transmitter, and may transmit/receive a signal to/from a terminal (UE) or a network entity. The signal transmitted or received to or from the terminal or a network entity may include control information and data. The transceiver 1010 may include a RF transmitter for up-converting and amplifying a frequency of a transmitted signal, and a RF receiver for amplifying low-noise and down-converting a frequency of a received signal. However, this is only an example of the transceiver 1010 and components of the transceiver 1010 are not limited to the RF transmitter and the RF receiver.

the transceiver 1010 may receive and output, to the processor 1030, a signal through a wireless channel, and transmit a signal output from the processor 1030 through the wireless channel.

The memory 1020 may store a program and data required for operations of the base station. Also, the memory 1020 may store control information or data included in a signal obtained by the base station. The memory 1020 may be a storage medium, such as ROM, RAM, a hard disk, a CD-ROM, and a DVD, or a combination of storage media.

The processor 1030 may control a series of processes such that the base station operates as described above. For example, the transceiver 1010 may receive a data signal including a control signal transmitted by the terminal, and the processor 1030 may determine a result of receiving the control signal and the data signal transmitted by the terminal.

The various illustrative logical blocks, modules, circuits, and steps described in this application may be implemented as hardware, software, or a combination of both. To clearly illustrate this interchangeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described functional sets in different ways for each specific application, but such design decisions should not be interpreted as causing a departure from the scope of this application.

The various illustrative logic blocks, modules, and circuits described in this application may be implemented or performed by a general purpose processor, a digital signal processor (DSP), an application specific integrated circuit (ASIC), a field programmable gate array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, more than one microprocessors, one or more microprocessors cooperating with a DSP core, or any other such configuration.

The steps of the method or algorithm described in this application may be embodied directly in hardware, in a software module executed by a processor, or in a combination thereof. The software module may reside in RAM memory, flash memory, ROM memory, erasable programmable ROM (EPROM) memory, electrically EPROM (EEPROM) memory, register, hard disk, removable disk, or any other form of storage medium known in the art. An exemplary storage medium is coupled to a processor to enable the processor to read and write information from/to the storage media. The storage medium may be integrated into the processor. The processor and the storage medium may reside in an ASIC. The ASIC may reside in a user terminal. The processor and the storage medium may reside in the user terminal as discrete components.

The functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

While the disclosure has been illustrated and described with reference to various embodiments of the present disclosure, those skilled in the art will understand that various changes can be made in form and detail without departing from the spirit and scope of the present disclosure as defined by the appended claims and their equivalents.

What is claimed is:

1. A method performed by a user equipment (UE) in a wireless communication system, the method comprising:
receiving, from a base station, configuration information related to a time-domain position of a signal;
identifying a time-domain position of a first signal according to the configuration information, the first signal being used for at least one of synchronization or a radio resource management (RRM) measurement; and
identifying a time-domain position of a monitoring occasion for a second signal based on the time-domain position of the first signal, the second signal being used for a wake-up.

2. The method of claim 1,
wherein the first signal and the second signal are wake up signals.

3. The method of claim 1, wherein identifying the time-domain position of the monitoring occasion for the second signal based on the time-domain position of the first signal comprises at least one of:
identifying a start point of the monitoring occasion for the second signal based on a start point or an end point of the first signal, and a preconfigured first offset; or
identifying an end point of the monitoring occasion for the second signal based on the start point or the end point of the first signal, and a preconfigured second offset.

4. The method of claim 1, wherein one or more second signals are configured in the monitoring occasion and are associated with a paging occasion (PO), the association comprising at least one of:
an i-th second signal of the one or more second signals being associated with K consecutive POs, wherein a start point of a first PO of the K consecutive POs is determined by an end point of the i-th second signal and a configured minimum time unit interval or offset, or
the one or more second signals being associated with all POs in a range from a start point of a first PO after a minimum time unit interval or offset from an end point of the monitoring occasion to a start point of a first PO associated with a next monitoring occasion.

5. The method of claim 1, wherein the configuration information comprises at least one of:
a maximum duration of the monitoring occasion,
a minimum time unit interval or offset from a first reference point at which an end point of the monitoring occasion is located to a second reference point, or
a cycle of the first signal,
wherein the first reference point comprises an end point of a time unit in which an end point of the monitoring occasion is located, and
wherein the second reference point comprises at least one of:
a start point of a first paging frame of paging frames associated with the monitoring occasion or a start point of a system frame number in which the paging frames associated with the monitoring occasion are located, or
a start point of a time unit in which a start point of a first associated PO in a first paging frame associated with the monitoring occasion is located.

6. A method performed by a base station in a wireless communication system, the method comprising:
transmitting, to a user equipment (UE), configuration information related to a time-domain position of a signal that is used to identify a time-domain position of a first signal used for synchronization and/or a radio resource management (RRM) measurement; and
transmitting, to the UE, a second signal used for wake-up,
wherein the second signal is monitored by the UE in a monitoring occasion for the second signal, and
wherein a time-domain position of the monitoring occasion is identified based on the time-domain position of the first signal.

7. The method of claim 6,
wherein the first signal and the second signal are wake up signals.

8. The method of claim 6,
wherein a start point of the monitoring occasion for the second signal is based on a start point or an end point of the first signal and a preconfigured first offset, and
wherein an end point of the monitoring occasion for the second signal is based on the start point or the end point of the first signal and a preconfigured second offset.

9. The method of claim 6, wherein one or more second signals are configured in the monitoring occasion and are associated with a paging occasion (PO), the association comprising at least one of:
an i-th second signal of the one or more second signals being associated with K consecutive POs, wherein a start point of a first PO of the K consecutive POs is determined by an end point of the i-th second signal and a configured minimum time unit interval or offset, or
the one or more second signals being associated with all POs in a range from a start point of a first PO after a minimum time unit interval or offset from an end point of the monitoring occasion to a start point of a first PO associated with a next monitoring occasion.

10. The method of claim 6, wherein the configuration information comprises at least one of:
a maximum duration of the monitoring occasion,
a minimum time unit interval or offset from a first reference point at which an end point of the monitoring occasion is located to a second reference point, or
a cycle of the first signal,
wherein the first reference point comprises an end point of a time unit in which an end point of the monitoring occasion is located, and
wherein the second reference point comprises at least one of:
a start point of a first paging frame of paging frames associated with the monitoring occasion or a start point of a system frame number in which the paging frames associated with the monitoring occasion are located, or
a start point of a time unit in which a start point of a first associated PO in a first paging frame associated with the monitoring occasion is located.

11. A user equipment (UE) in a wireless communication system, the UE comprising:
a transceiver; and
a controller coupled with the transceiver and configured to:
receive, from a base station, configuration information related to a time-domain position of a signal,
identify a time-domain position of a first signal according to the configuration information, the first signal being used for at least one of synchronization or a radio resource management (RRM) measurement, and
identify a time-domain position of a monitoring occasion for a second signal based on the time-domain position of the first signal, the second signal being used for wake-up.

12. The UE of claim 11,
wherein the first signal and the second signal are wake up signals.

13. The UE of claim 11, wherein the controller is further configured to:
identify a start point of the monitoring occasion for the second signal based on a start point or an end point of the first signal, and a preconfigured first offset; or
identify an end point of the monitoring occasion for the second signal based on the start point or the end point of the first signal, and a preconfigured second offset.

14. The UE of claim 11, wherein one or more second signals are configured in the monitoring occasion and are associated with a paging occasion (PO), the association comprising at least one of:
an i-th second signal of the one or more second signals being associated with K consecutive POs, wherein a start point of a first PO of the K consecutive POs is determined by an end point of the i-th second signal and a configured minimum time unit interval or offset, or
the one or more second signals being associated with all POs in a range from a start point of a first PO after a minimum time unit interval or offset from an end point of the monitoring occasion to a start point of a first PO associated with a next monitoring occasion.

15. The UE of claim 11, wherein the configuration information comprises at least one of:
a maximum duration of the monitoring occasion,
a minimum time unit interval or offset from a first reference point at which an end point of the monitoring occasion is located to a second reference point, or
a cycle of the first signal,
wherein the first reference point comprises an end point of a time unit in which an end point of the monitoring occasion is located, and
wherein the second reference point comprises at least one of:
a start point of a first paging frame of paging frames associated with the monitoring occasion or a start point of a system frame number in which the paging frames associated with the monitoring occasion are located, or
a start point of a time unit in which a start point of a first associated PO in a first paging frame associated with the monitoring occasion is located.

16. A base station in a wireless communication system, the base station comprising:
a transceiver; and
a controller coupled with the transceiver and configured to:
transmit, to a user equipment (UE), configuration information related to a time-domain position of a signal that is used to identify a time-domain position of a first signal used for synchronization and/or a radio resource management (RRM) measurement, and
transmit, to the UE, a second signal used for wake-up,
wherein the second signal is monitored by the UE in a monitoring occasion for the second signal, and
wherein a time-domain position of the monitoring occasion is identified based on the time-domain position of the first signal.

17. The base station of claim 16,
wherein the first signal and the second signal are wake up signals.

18. The base station of claim 16,
wherein a start point of the monitoring occasion for the second signal is based on a start point or an end point of the first signal and a preconfigured first offset, and
wherein an end point of the monitoring occasion for the second signal is based on the start point or the end point of the first signal and a preconfigured second offset.

19. The base station of claim 16, wherein one or more second signals are configured in the monitoring occasion and are associated with a paging occasion (PO), the association comprising at least one of:
an i-th second signal of the one or more second signals being associated with K consecutive POs, wherein a start point of a first PO of the K consecutive POs is determined by an end point of the i-th second signal and a configured minimum time unit interval or offset, or
the one or more second signals being associated with all POs in a range from a start point of a first PO after a minimum time unit interval or offset from an end point of the monitoring occasion to a start point of a first PO associated with a next monitoring occasion.

20. The base station of claim 16, wherein the configuration information comprises at least one of:
a maximum duration of the monitoring occasion,
a minimum time unit interval or offset from a first reference point at which an end point of the monitoring occasion is located to a second reference point, or
a cycle of the first signal,
wherein the first reference point comprises an end point of a time unit in which an end point of the monitoring occasion is located, and
wherein the second reference point comprises at least one of:
a start point of a first paging frame of paging frames associated with the monitoring occasion or a start point of a system frame number in which the paging frames associated with the monitoring occasion are located, or
a start point of a time unit in which a start point of a first associated PO in a first paging frame associated with the monitoring occasion is located.
